(19) United States
(12) Patent Application Publication
(10) Pub. No.: US 2021/0192521 A1
(43) Pub. Date: Jun. 24, 2021

(54) SYSTEMS AND METHODS FOR DISTRIBUTED IDENTITY VERIFICATION DURING A TRANSACTION

(71) Applicant: SecureKey Technologies Inc., Toronto (CA)

(72) Inventors: Dmitry Barinov, Maple (CA); Michael Varley, Toronto (CA); Gregory Howard Wolfond, Toronto (CA); Salavat Nabiev, Toronto (CA)

(73) Assignee: SecureKey Technologies Inc., Toronto (CA)

(21) Appl. No.: 17/190,901

(22) Filed: Mar. 3, 2021

Related U.S. Application Data
(63) Continuation of application No. PCT/CA2019/051292, filed on Sep. 12, 2019.
(60) Provisional application No. 62/730,673, filed on Sep. 13, 2018.

(51) Int. Cl. G06Q 20/40; G06Q 20/38

(52) U.S. Cl. CPC G06Q 20/4014; G06Q 20/3821

(57) ABSTRACT

Various embodiments are described herein for methods, devices and systems that can be used to authenticate a user identity attribute associated with a user during a transaction with a merchant. In one example embodiment, the method comprises receiving, at a payment processor, a unique identifier corresponding to a payment instrument provided by the user at a merchant terminal where the payment instrument is pre-linked to one or more user identity attributes, transmitting the unique identifier to an issuer network for payment verification, generating a transaction approval indicator and transmitting the unique identifier and an identity verification request from the payment processor to the third party server if payment verification is successful, receiving the one or more user identity attributes associated with the unique identifier from a third party server, and subsequently transmitting the one or more user identity attributes and the transaction approval indicator to the merchant terminal.

### CROSS-REFERENCE TO RELATED APPLICATIONS

This patent application is a continuation of International Application No. PCT/CA2019/051292, filed Sep. 12, 2019, which claims the benefit of U.S. Provisional Application No. 62/730,673, filed Sep. 13, 2018, the disclosures of which are incorporated herein by reference.

### FILED

The described embodiments relate to identity verification in electronic systems and, in particular, to identity verification in a networked environment, such as the Internet, during a payment transaction.

### BACKGROUND

Certain financial operations require verification of user's identity before the operations can be completed. For example, if the financial operation relates to a transaction with a merchant, the merchant may want to verify the age of the purchaser before selling certain merchandise, such as alcohol or tobacco, to the purchaser.

Typically, it is incumbent upon the user or the purchaser of such merchandise to produce valid identification and proof of a user's identity information, such as the user's age, at every transaction. The merchant verifies the produced identification, and allows or refuses the transaction based on the verification.

However, the traditional exchange of identity information tends to be inefficient, restrictive, slow and insecure. By requiring the purchaser to provide identification at various transactions, the purchaser may risk exposing more personal or sensitive details than desired or even required to complete the transaction. In addition, the purchaser may be unduly burdened to carry around more identification documents than desirable. This may make the purchaser vulnerable to lost or stolen identification documents, and in some case, stolen identity. These and other drawbacks highlight the need for improved methods and systems for electronic identity provision and verification.

### SUMMARY

In a broad aspect, in at least one embodiment described herein, there is provided a method for authenticating a user identity attribute associated with a user during a transaction with a merchant, where the user operates a user device and is related to a user agent server.

The method generally comprises receiving, at a payment processor, at least one unique identifier corresponding to a first payment instrument provided by the user at a merchant terminal, the first payment instrument being pre-linked to one or more user identity attributes by a third party server; transmitting the at least one unique identifier to an issuer network for payment verification; if payment verification is successful, generating a transaction approval indicator, and transmitting the at least one unique identifier and an identity verification request from the payment processor to the third party server; in response to the identity verification request, receiving the one or more user identity attributes associated with the at least one unique identifier from the third party server; and subsequently transmitting the one or more user identity attributes and the transaction approval indicator to the merchant terminal.

In some embodiments, the at least one unique identifier comprises a primary account number associated with the first payment instrument.

In some other embodiments, the at least one unique identifier comprises a hash of a primary account number associated with the first payment instrument.

In some further embodiments, the at least one unique identifier comprises a cryptogram based on a primary account number associated with the first payment instrument, where the cryptogram is an encrypted version of the primary account number.

In some embodiments, at least one user identity attribute transmitted to the merchant terminal comprises a photograph of the user.

In some other embodiments, at least one user identity attribute transmitted to the merchant terminal comprises an age of the user.

In some embodiments, the method for authenticating the user identity attribute associated with the user further comprises receiving a cancellation request, at the payment processor, from the merchant terminal, the cancellation request being generated if the one or more user identity attributes fail to meet one or more identity conditions associated with the transaction; and storing the cancellation request and the at least one unique identifier associated with the first payment instrument.

In some other embodiments, the method for authenticating the user identity attribute associated with the user further comprises receiving an approval request, at the payment processor, from the merchant terminal, the approval request being generated if the one or more user identity attributes meet one or more identity conditions associated with the transaction; and storing the approval request and the at least one unique identifier associated with the first payment instrument.

In some embodiments, the third party server determines the one or more user identity attributes based on the at least one unique identifier in response to the identity verification request.

In some embodiments, the third party server transmits the at least one unique identifier associated with the first payment instrument to the issuer network to detokenize the at least one unique identifier and generate a corresponding at least one processed unique identifier, and wherein the third party server determines the one or more user identity attributes based on the at least one processed unique identifier in response to the identity verification request.

In another aspect, in at least one embodiment described herein, there is provided an authentication system for authenticating a user identity attribute associated with a user during a transaction with a merchant. The system comprises a memory unit; and a processing unit coupled to the memory unit. The processing unit is configured to receive at least one unique identifier corresponding to a first payment instrument provided by the user at a merchant terminal, the first payment instrument being provided by the user for purchase of a good or service from the merchant, the first payment instrument being pre-linked to one or more user identity attributes by a third party server; transmit the at least one unique identifier to an issuer network for payment verification; if payment verification is successful, generate a transaction approval indicator, and transmit the at least one unique identifier and an identity verification request to the third party server; in response to the identity verification request, receive the one or more user identity attributes associated with the at least one unique identifier from the third party server; and subsequently transmit the one or more user identity attributes and the transaction approval indicator to the merchant terminal.

In another embodiment, the processing unit is configured to perform the methods as defined above or other methods in accordance with the teachings herein.

In another aspect, in at least one embodiment described herein, there is provided a computer-readable medium storing computer-executable instructions. The instructions cause a processor to perform a method for authenticating a user identity attribute associated with a user during a transaction with a merchant, where the user operates a user device and is related to a user agent server, the method comprising: receiving, at a payment processor, at least one unique identifier corresponding to a first payment instrument provided by the user at a merchant terminal, the first payment instrument being pre-linked to one or more user identity attributes by a third party server; transmitting the at least one unique identifier to an issuer network for payment verification; if payment verification is successful, generating a transaction approval indicator, and transmitting the at least one unique identifier and an identity verification request from the payment processor to the third party server; in response to the identity verification request, receiving the one or more user identity attributes associated with the at least one unique identifier from the third party server; and subsequently transmitting the one or more user identity attributes and the transaction approval indicator to the merchant terminal.

In some embodiments, the instructions cause the processor to perform the methods as described above or other methods in accordance with the teachings herein.

In a further aspect, in at least one embodiment described herein, there is provided a method for linking a user identity attribute associated with a user to a payment instrument associated with the user to facilitate a transaction between a merchant and the user, where the user is related to a user agent server.

The method generally comprises transmitting, from an identity management server, a link request to the user agent server; in response to the link request, receiving, at the identity management server, a data bundle identifying at least one user identity attribute associated with the user and at least one unique identifier associated with a corresponding at least one payment instrument associated with the user; receiving, at the identity management server, a consent input from the user agent server, the consent input identifying a user permission to link the user identity attribute with the payment instrument; and based on the consent input, generating a data record linking the at least one unique identifier with the data bundle, wherein if the identity management server is queried using the at least one unique identifier, a response signal associated with the data bundle is generated.

In some embodiments, the method for linking the user identity attribute associated with the user to the payment instrument associated with the user further comprises receiving at least one payment transaction request from the user agent server, the at least one payment transaction request being generated using a corresponding at least one payment instrument associated with the user, each of the at least one payment transaction request identifying a unique identifier associated with the corresponding at least one payment instrument; for each of the at least one payment transaction request: processing that payment transaction request for a corresponding payment verification; and if payment verification is successful, processing that payment transaction request to generate the unique identifier associated with the payment instrument corresponding to that payment transaction.

In some embodiments, for each of the at least one payment transaction request, the method further comprises: transmitting the unique identifier to an issuer network to detokenize the unique identifier associated with the payment instrument related to the user; and generating a corresponding processed unique identifier, wherein the data record is updated to additionally link the processed unique identifier with the data bundle of the user.

In some embodiments, the response signal comprises the data bundle.

In some other embodiments, the response signal comprises the at least one user identity attribute contained in the data bundle.

In some embodiments, the data bundle is generated by an identity provider server.

In some embodiments, the data bundle is received from the identity provider server based on user authorization to release the data bundle.

In some embodiments, the data bundle is stored locally at the user agent server.

In some other embodiments, the data bundle is received by the identity management server from the user agent server.

In some other embodiments, the data bundle is generated by an identity provider server based on a user request to generate the data bundle, the user request identifying one or more claim categories.

In some embodiments, the method for linking the user identity attribute associated with the user to the payment instrument associated with the user further comprises receiving an identity verification request from a payment processor server, the identity verification request identifying a unique identifier; querying the data record based on the unique identifier to generate one or more user identity attributes; and subsequently generating the response signal for transmission to the payment processor server, the response signal comprising the one or more user identity attributes.

In another aspect, in at least one embodiment described herein, there is provided a system for linking a user identity attribute associated with a user to a payment instrument associated with the user to facilitate a transaction between a merchant and the user. The system comprises a memory unit; and a processing unit coupled to the memory unit. The processing unit is configured to transmit a link request to a user agent server; in response to the link request, receive a data bundle identifying at least one user identity attribute associated with the user and at least one unique identifier associated with a corresponding at least one payment instrument associated with the user; receive a consent input from the user agent server, the consent input identifying a user permission to link the user identity attribute with the payment instrument; and based on the consent input, generate a data record linking the at least one unique identifier with the data bundle, wherein if the processing unit is queried using the at least one unique identifier, a response signal associated with the data bundle is generated.

In another embodiment, the processing unit is configured to perform the methods as defined above or other methods in accordance with the teachings herein.

In another aspect, in at least one embodiment described herein, there is provided a computer-readable medium storing computer-executable instructions. The instructions cause a processor to perform a method for linking a user identity attribute associated with a user to a payment instrument associated with the user, the method comprising: transmitting, from an identity management server, a link request to the user agent server; in response to the link request, receiving, at the identity management server, a data bundle identifying at least one user identity attribute associated with the user and at least one unique identifier associated with a corresponding at least one payment instrument associated with the user; receiving, at the identity management server, a consent input from the user agent server, the consent input identifying a user permission to link the user identity attribute with the payment instrument; and based on the consent input, generating a data record linking the at least one unique identifier with the data bundle, wherein if the identity management server is queried using the at least one unique identifier, a response signal associated with the data bundle is generated.

In some embodiments, the instructions cause the processor to perform the methods as described above or other methods in accordance with the teachings herein.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from the detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment and the figures will now be briefly described.

FIG. 1 is a schematic block diagram of a traditional transaction system according to the prior art;

FIG. 2 is a simplified process flow diagram for the transaction system of FIG. 1;

FIG. 3 is an example of a schematic block diagram of a transaction system according to one embodiment of the present invention;

FIG. 4 is an example of a process flow diagram for the transaction system of FIG. 3;

FIG. 5 is another example of a process flow diagram for the transaction system of FIG. 3;

FIG. 6 is a further example of a process flow diagram for the transaction system of FIG. 3;

FIG. 7 is another example of a process flow diagram for the transaction system of FIG. 3;

FIG. 8 is a further example of a process flow diagram for the transaction system of FIG. 3;

FIG. 9 is an example of a schematic block diagram of an identity management system;

FIG. 10 is an example of a schematic block diagram of a user system; and

FIG. 11 is an example of a schematic block diagram of a payment processing system.

The skilled person in the art will understand that the drawings, described below, are for illustration purposes only. The drawings are not intended to limit the scope of the applicants' teachings in anyway. Also, it will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF EXEMPLARY EMBODIMENTS

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail since these are known to those skilled in the art. Furthermore, it should be noted that this description is not intended to limit the scope of the embodiments described herein, but rather as merely describing one or more exemplary implementations.

It should also be noted that the terms “coupled” or “coupling” as used herein can have several different meanings depending in the context in which these terms are used. For example, the terms coupled or coupling may be used to indicate that an element or device can electrically, optically, or wirelessly send data to another element or device as well as receive data from another element or device.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a keyboard, mouse, touchscreen, or the like), and at least one output device (e.g. a display screen, a printer, a wireless radio, or the like) depending on the nature of the device.

It should also be noted that there may be some elements that are used to implement at least part of one of the embodiments described herein that may be implemented via software that is written in a high-level computer programming language such as one that employs an object oriented paradigm. Accordingly, the program code may be written in Java, C++ or any other suitable programming language and may comprise modules or classes, as is known to those skilled in object oriented programming. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage.

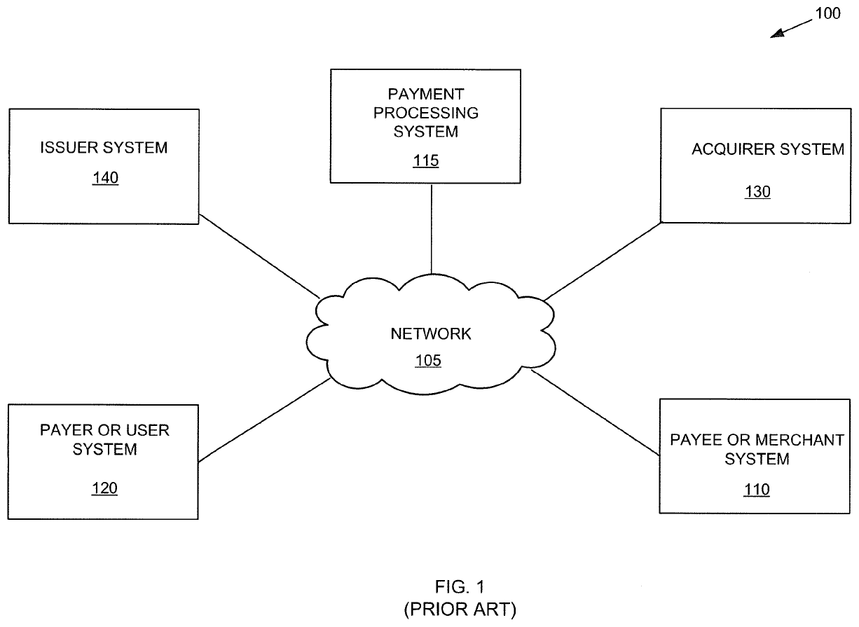

Referring now to FIG. 1, there is illustrated a schematic block diagram of a traditional transaction system according to prior art. The traditional transaction system 100 includes a network 105, a payee system 110, a payment processing system 115, a payer system 120, an acquirer system 130 and an issuer system 140.

Network 105 may be any network or network components capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network (LAN), wide area network (WAN), a direct point-to-point connection, mobile data networks (e.g., Universal Mobile Telecommunications System (UMTS), 3GPP Long-Term Evolution Advanced (LTE Advanced), Worldwide Interoperability for Microwave Access (WiMAX), etc.), radiofrequency identification (RFID) systems, near frequency communication (NFC) enabled networks, short-wavelegnth wireless communication networks (e.g. Bluetooth®) and others, including any combination of these.

Issuer system 140 may be a networked computing device or a server including a processor and memory, and being capable of communicating with the network 105. Issuer system 140 may alternatively be a distributed system including more than one networked computing devices or servers capable of communicating with each other. The distributed system implementation of the issuer system 140 may have one or more processors with computing processing abilities and memory such as a database(s) or file system(s).

Issuer system 140 may be a financial institution, such as a bank, or any other legal entity that stores and safeguards value of a currency on behalf of the consumer or payer system 120. The primary function of the issuer system 140 is to control the flow of currency into and out of circulation within the transaction system 100. In various embodiments, the issuer system 140 issues currency to the payer system 120.

The payer system 120 is any device that can be used by a user or a consumer to participate in a transaction with a merchant. In some embodiments, the payer system 120 is any payment instrument, such as a debit card, a credit card, a store issued card, a points card etc. that can be used by the consumer to transact with the merchant.

In some other embodiments, the payer system 120 is any networked computing device, which includes a processor and memory, and is capable of communicating with the network 105. A computing device may be a personal computer, a portable computer, a mobile phone, a laptop, a wirelessly enabled personal data assistant (PDA), a smart phone, a terminal, a tablet computer, a game console over a wired or wireless connection, a WAP phone, an embedded device, a smart card, or a combination of these.

In various embodiments, the payer system 120 comprises a client or a wallet which may be an application, such as a computing application, application plug-in, a widget, mobile device application, Java™ application, or web browser executed by the payer system 120 in order to send or transmit data. The client or the wallet may include any software that runs on various platforms (e.g. on a personal computer, mobile phone, cloud environment etc.), and may be configured to communicate with the issuer system 140 over the network 105 to securely store currency, to manage the logical linkages with the issuer system 140, to provide a user interface, and to maintain transaction records (for example, logs and digital receipts etc.). The payer system 120 is operated by a consumer, who uses the currency stored in the wallet to make a purchase with the merchant or the payee system 110.

The payee system 110 is any networked computing device, including a processor and memory, and is capable of communicating with a network, such as network 105. The computing device may be a personal computer, a workstation, a server, a portable computer, a mobile phone, a laptop wirelessly coupled to an access point (e.g. a wireless router, a cellular communications tower, etc.), a wirelessly enabled personal data assistant (PDA) or a smart phone, a terminal, a tablet computer, a game console over a wired or wireless connection, a WAP phone, or a combination of these.

The payee system 110 may also include a merchant website, a network location, a point of sale (POS) terminal, an automated teller machine (ATM) terminal, or any merchant data source providing products or services and operations data associated with one or more merchants. In various embodiments, the products or services and operations data includes, but is not limited to, one or more of, data indicating the products or services offered by the potential merchant payees, data indicating the prices of the products or services offered by the potential merchant payees, data indicating the payment polices of the potential merchant payees, such as data indicating if the potential merchant payees accept cash, or provide products or services typically paid for using cash, data indicating the hours of operation of the potential merchant payees, data indicating days the potential merchant payees are closed, the holidays observed by the potential merchant payees, and/or any other products or services and operations data associated with the potential merchant payees.

The acquirer system 130 may be a networked computing device or a server including a processor and memory, and is capable of communicating with the network 105. The acquirer system 130 may alternatively be a distributed system including more than one networked computing devices or servers capable of communicating with each other. The distributed system implementation of the acquirer system 130 may have one or more processors with computing processing abilities and memory such as a database(s) or file system(s).

Acquirer system 130 is controlled and operated by an acquirer, who is a legal entity that accepts value on behalf of the payee who controls the payee system 110. The acquirer system 130 is further configured to accept obligations to settle accounts with merchant/payee operating the payee system 110. In some embodiments, the acquirer system 130 may be configured to handle multiple types of settlements, including but not limited to, real-time gross settlement (RTGS), batch format and time-based batch format. The acquirer system 130 may be a financial institution, such as a bank, or any other legal entity that stores and safeguards value of a currency on behalf of the merchant or payee system 110.

The payment processing system 115 may be a networked computing device or a server including a processor and memory, and is capable of communicating with a network, such as network 105. The payment processing system 115 may alternatively be a distributed system including more than one networked computing devices or servers capable of communicating with each other. The distributed system implementation of the payment processing system 115 may have one or more processors with computing processing abilities and memory such as a database(s) or file system(s).

The payment processing system 115 is configured to provide authorization, clearing and settlement services for payment transactions. The payment processing system 115 is also configured to act as an arbiter between the issuer system 140 and the acquirer system 130. Examples of payment processing system 115 includes VisaNet™ operated by Visa, BankNet™ operated by MasterCard etc.

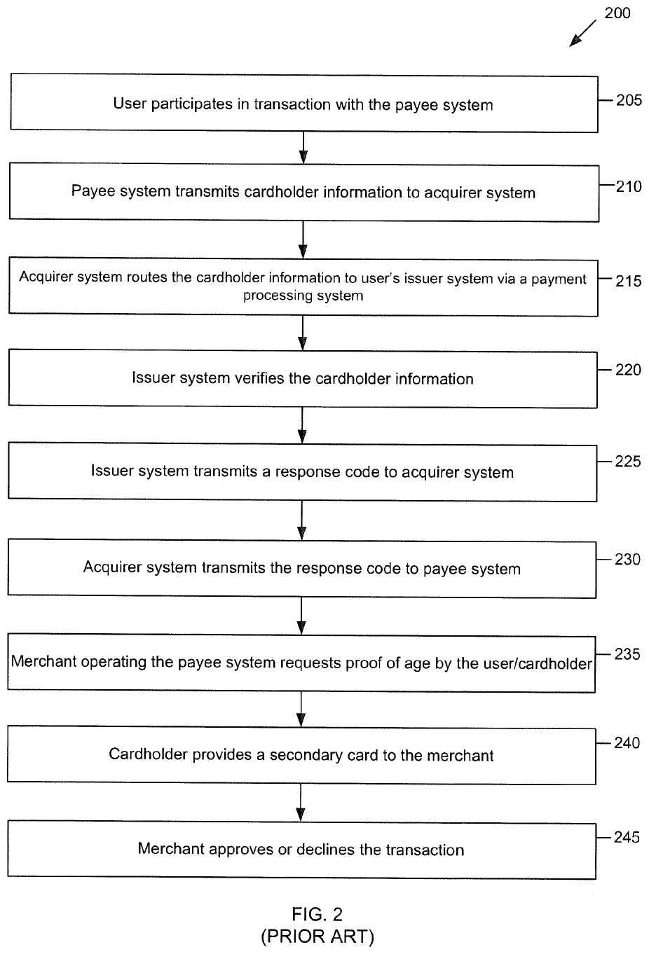

Reference is made to FIG. 2, which illustrates a simplified process flow diagram for the transaction system of FIG. 1, according to the prior art.

Flow 200 begins at 205 where the payer system 120 is used by a user to participate in a transaction with the payee system 110. For example, the user begins a credit card transaction with a merchant operating the payee system 110 by presenting his or her card to the merchant.

At 210, the payee system 110 receives the information associated with the payer system 120, and transmit the cardholder's information and details about the transaction to their acquirer system 130.

At 215, the acquirer system 130 captures the transaction information and routes it through the payment processing system 115 to the cardholder's issuer system 140.

At 220, the issuer system 140 receives the transaction information from the acquirer system 130 through the payment processing system 115, and responds by approving or declining the transaction after checking to ensure that the transaction information is valid, the cardholder has sufficient balance to make the purchase and that the account is in good standing.

At 225, the issuer system 140 transmits a response code through the appropriate payment processing system 115 to the acquirer system 130.

At 230, the response code is transmitted to the payee system 110, based on which the merchant can approve or decline the transaction.

At 235, the merchant operating the payee system 110 requests proof of age from the cardholder.

At 240, the cardholder provides a secondary card, such as a driver's license, a health card, a passport etc., to the merchant so that the merchant can verify the age of the cardholder before approving or declining the transaction.

At 245, the merchant confirms that the cardholder meets the predetermined age requirement for the transaction, and accordingly approves the transaction.

According to flow 200, the payee system 110 requires the cardholder to provide proof of age to authenticate the identity of the cardholder. In doing so, the cardholder unintentionally and unwillingly has to provide other personal data, such as cardholder's address, license number, health card number, passport number etc. to the merchant. As well, in the event the cardholder does not have any secondary instruments to establish proof of age in his/her possession at the time of the transaction, the transaction will not be approved. Furthermore, such a process is time consuming and prone to errors. The various embodiments disclosed herein alleviate these advantages associates with the traditional transaction system 100.

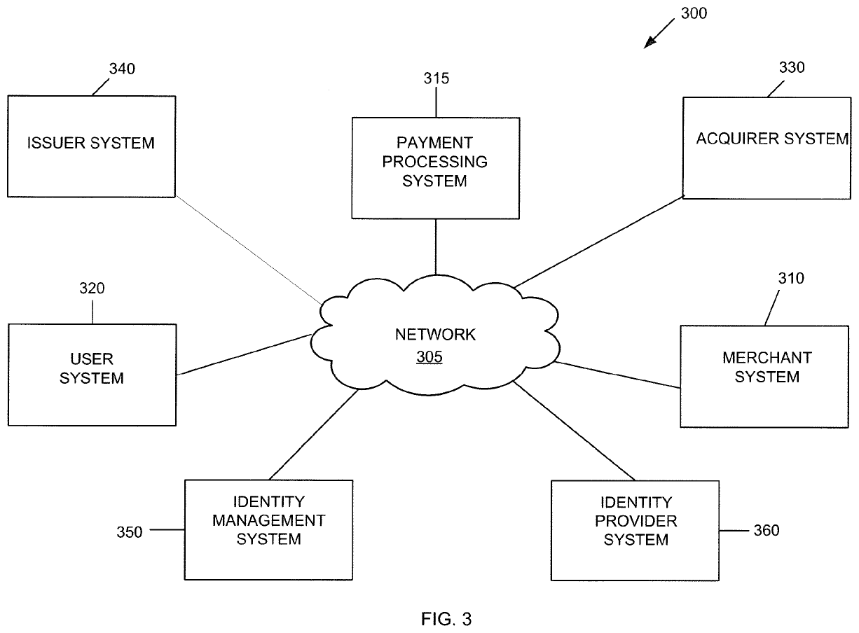

Reference is next made to FIG. 3, which illustrates a transaction system 300 according to the teachings of the various embodiments described herein. The transaction system 300 includes a network 305, a merchant system 310, a payment processing system 315, a user system 320, an acquirer system 330, an issuer system 340, an identity management system 350 and an identity provider system 360.

The merchant system 310, the acquirer system 330 and the issuer system 340 of FIG. 3 are analogous to the payee system 110, the acquirer system 130 and the issuer system 140 of FIG. 1.

The user system 320 of FIG. 3 is analogous to the payer system 120 of FIG. 1, with the exception that the user system 320 is additionally configured to additionally correspond with the identity management system 350 and the identity provider system 360 via the network 305, as discussed in detail below.

Similarly, the payment processing system 315 is analogous to the payment processing system 115 of FIG. 1, with the exception that the payment processing system 315 is additionally configured to additionally correspond with the identity management system 350 and the identity provider system 360 via the network 305, as discussed in detail below.

The identity management system 350 is a networked computing device or a server including a processor and memory, and is capable of communicating with a network, such as network 305. The identity management system 350 may alternatively be a distributed system including more than one networked computing devices or servers capable of communicating with each other. The distributed system implementation of the identity management system 350 may have one or more processors with computing processing abilities and memory such as a database(s) or file system(s).

The identity management system 350 is configured to link a user identity attribute associated with a user to a payment instrument associated with the user in order to facilitate a transaction between a user system 320 and the merchant system 310.

The user identity attributes can include data such as: user identification information (e.g., name, age, citizenship, driver's license number, etc.); information about a user's property or assets (e.g., car license plate number, home address, residence status, credit score etc.); items in the possession of a user (e.g., shareholder certificate, lottery ticket, fishing license or quota, warranties, etc.), education information (e.g., student enrollment status, student identifier, etc.), employment information (e.g., employer, employee ID, employee position, etc.), health information (e.g., medical records, insurance information, etc.), user's photograph, and many others.

The identity management system 350 is configured to maintain a database of user records. The user records include a correlation of one or more user identity attributes associated with the user and identifiers associated with one or more payment instruments of the user. For example, the database maintained by the identity management system 350 includes identifiers associated with one or more credit or debit cards. The database further includes, for each credit or debit card identifier, a corresponding one or more identity attribute, such as age, picture, residence status etc. associated with the user. The correlation between the identity attributes and the payment instruments is pre-approved by the user during an onboarding process, as discussed in detail below.

In at least one embodiment, the identity management system 350 transmits a link request to the user system 320 in order to prompt the user to correlate the user's identity attributes to the payment instruments. In response to the link request, the user system 320 may transmit a data bundle of one or more identity attributes to the identity management system 350. In addition, the user system 320 transmits a unique identifier associated with a payment instrument associated with the user with which the user wants to correlate the identity attributes.

In some cases, the user system 320 additionally transmits a consent input from the user system 320 to the identity management system 350, where the consent input indicates user's consent or permission to link the user identity attribute with the payment instrument. In some other cases, the transmission of the one or more identity attributes and the unique identifier(s) of one or more payment instruments indicates the user's consent to link the identity attribute with the payment instrument. In such cases, a separate consent input from the user system 320 is not required.

In one example, the unique identifier associated with the payment instrument includes a primary account number associated with the payment instrument.

In another example, the unique identifier associated with the payment instrument includes a cryptogram based on a primary account number of the payment instrument. In this example, the cryptogram is generated by encrypting the primary account number of the payment instrument.

In another example, the unique identifier associated with the payment instrument includes a hash of the primary account number associated with the payment instrument.

The identity management system 320 may be configured to transmit the data bundle stored in the database when the system 320 is queried using a unique identifier that corresponds to the payment instrument associated with the user. In some cases, the identity management system 320 generates a response signal associated with the data bundle.

In at least one embodiment, the identity management system 350 includes a system of ledgers that can be queried, while maintaining the privacy of users of the transaction system 300. In various embodiments, the identity management system 350 is capable of enhancing privacy, auditing, monitoring and assurance levels by employing blockchain-type ledgers, including private participant ledgers that can be monitored to ensure proper service behavior in a way that nevertheless protects the user's privacy and confidentiality during operation.

Blockchain-type ledgers can be used to provide system auditing, monitoring and usage statistics, while preserving participant privacy and confidentiality. Such Service Ledgers offer the ability to deliver proof that events and transactions occurred and were authorized, deliver proof that data is valid (or has become stale, been revoked, or never even issued), and allow participants to monitor the behavior of the system as it relates to them, but not that of other participants. In addition, the Service Ledgers offer the ability to hide some event and transaction data during normal operation, such that entities are unable to perform user tracking. However, in exceptional circumstances, such as under a court order, the hidden data of a particular transaction can be revealed and proven to be part of the ledger.

The Service Ledgers also allow system operators to demonstrate that the ledgers have not been manipulated. In addition, the Service Ledgers can efficiently collect new events and prove that events are part of the ledgers, provide ledger replication and query capabilities to the appropriate participants to enable monitoring and auditing, enable the creation of usage statistics without sacrificing participant privacy, minimize the impact of a breach of a single component without compromising the overall system; and minimize the impact of a compromised entry to the entry itself, and not the overall system.

In the various embodiments disclosed herein, the blockchain-based identity management system 350 preserves the interactions between the identity management system 350 and the various components of the transaction system 300 into a hash chain structure. A hash chain provides an audit trail, typically immutable, where interactions that are received within the same time period (typically seconds) are organized into blocks, and each block contains evidence of the previous block's contents (typically as hashes). In this way, an investigator can iterate backwards from a starting block to a block containing an interaction of interest and have confidence that these blocks have not been modified.

The identity provider system 360 is a networked computing device or a server including a processor and memory, and is capable of communicating with a network, such as network 305. The identity provider system 360 may alternatively be a distributed system including more than one networked computing devices or servers capable of communicating with each other. The distributed system implementation of the identity provider system 360 may have one or more processors with computing processing abilities and memory such as a database(s) or file system(s).

The identity provider system 360 may be configured to issue data bundles of desired identity attributes to the user system 320. In at least one configuration, the identity provider system 360 receives a request from the user system 320 to issue a data bundle of desired user attribute or attributes. In response, the identity provider system 360 authenticates the user system 320 and subsequently issues the data bundle containing the desired user attribute or attributes.

For example, in one case, the user system 320 sends a request to the identity provider system 360 operated by a bank to issue a data bundle verifying the user's address. In response, the identity provider system 360 authenticates the user system 320 and issues a data bundle containing the user's mailing address, which has been previously verified by the bank.

The identity provider system 360 is monitored or operated by an identity provider, or a consortium of identity providers. The identity provider system 360 is generally provided or operated by an entity that can provide one or more user identity attributes, because the user has some sort of relationship with the entity. For example, the entity may be a financial institution or a government agency. In many cases, the entity will have procedures for the real-world verification of identity attributes, which means that identity attributes will have strong assurances when their origin is the identity provider system 360. The identity provider system 360 may be configured to provide users with assurance that data, events and transactions related to user's identity attributes are valid, authentic and provided with user's consent.

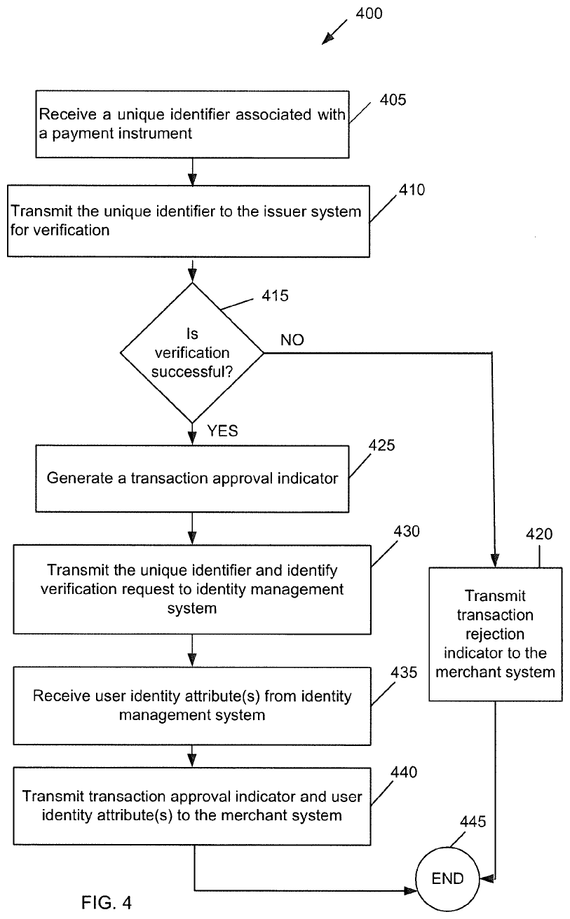

Reference is next made to FIG. 4, which illustrates an example of a process flow diagram of a transaction system according to the teachings herein, such as the transaction system 300 of FIG. 3. The various steps of the process flow of FIG. 4 are carried out by a payment processor, such as VisaNet™ operated by Visa, BankNet™ operated by MasterCard, or any other payment processor provided in a transaction system, such as transaction system 300.

Process flow 400 begins at 405, where the payment processor receives a unique identifier associated with a payment instrument belong to a user. The payment instrument is any payment instrument provider by a user or the user system 320 at a merchant system 310 to engage in a transaction with the merchant operating the merchant system 310. The merchant system 310 may be a merchant's POS terminal.

As disclosed herein, the payment instrument is pre-linked or correlated to one or more identity attributes of the user. For example, the payment instrument may be correlated to user's age, citizenship, address, photograph, nationality, or a combination of these.

In some cases, the unique identifier includes the primary account number associated with the user's payment instrument. In some other cases, the unique identifier includes a hash of the primary account number associated with the user's payment instrument.

In some further case, the unique identifier includes a cryptogram based on the primary account number associated with the user's payment instrument. The cryptogram may be an encrypted version of the primary account number.

In some cases, the unique identifier is received by the payment processor from the merchant system 310. In some other cases, the unique identifier is received by the payment processor from the acquirer system 330.

At 410, the payment processor transmits the unique identifier associated with the payment instrument to the issuer system 340 for payment verification. The issuer system 340 verifies that the user or the user system 120 associated with the payment instrument has available funds for credit. The payment processor receives a verification response from the issuer system 340 based on whether or not the payment transaction verification is successful or not.

At 415, the payment processor determines whether or not the verification response from the issuer system 340 indicates a successful or unsuccessful verification. If the payment processor determines that the verification was unsuccessful, the process flow proceeds to 420 where the payment processor transmits a transaction rejection indicator to the merchant system 310, either directly or via the acquirer system 330.

On the other hand, if the payment processor determines that the verification was successful, the process flow proceeds to 425, where the payment processor generates a transaction approval indicator. Next, at 430, the payment processor transmits the unique identifier associated with the payment instrument along with a user identity verification request to an identity management system, such as the identity management system 350.

At 435, the payment processor receives one or more user identity attributes associated with the unique identifier of the user's payment instrument. The one or more user identity attributes may be in the form of data bundles as discussed in detail herein.

Some non-limiting examples of the user identity attributes received from the identity management system may include age, face, name, residence status, citizenship information, credit card score etc.

At 440, the payment processor transmits the one or more user identity attributes and the transaction approval indicator to the merchant system 310. The one or more user identity attributes and the transaction approval indicator may be transmitted to the merchant system 310 either directly, or via the acquirer system 330. In some cases, the one or more user identity attributes are transmitted to the merchant system 310 from the payment processor directly, and the transaction approval indicator is transmitted to the merchant system 310 via the acquirer system 330. The process flow ends at 445.

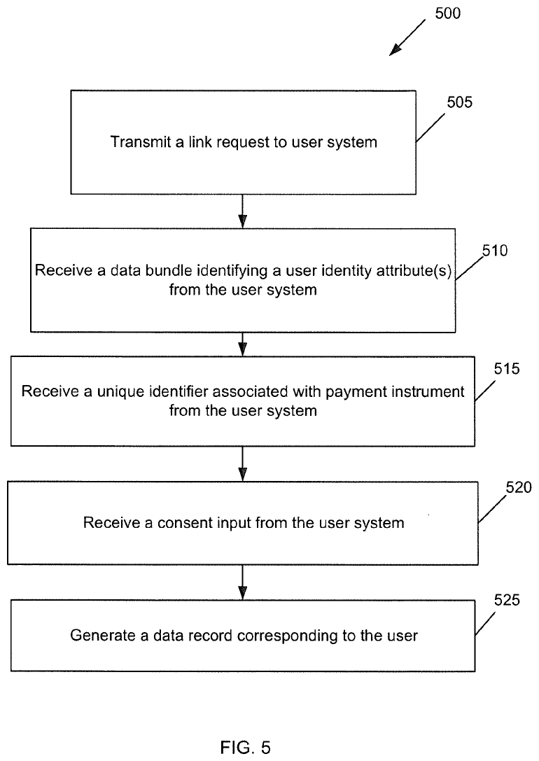

Reference is next made to FIG. 5, which illustrates an example of a process flow diagram of a transaction system according to the teachings herein, such as the transaction system 300 of FIG. 3. The various steps of the process flow of FIG. 5 are carried out by an identity management system, such as the identity management system 350 of FIG. 3.

Process flow 500 begins at 505. At 505, the identity management system 350 transmits a link request to a user via the user system 320. The link request prompts the user to link one or more identity attributes of the user to one or more payment instruments of the user.

At 510, the identity management system 350 receives one or more data bundles, each identifying one or more user identity attributes that the user wishes to link to the payment instrument(s). In some cases, each data bundle corresponds to a unique user identity attribute. In some other cases, each data bundle corresponds to multiple user identity attributes. The data bundle(s) are received from the user system 320.

At 515, the identity management system 350 receives one or more payment instrument identifiers, each payment instrument identifier being uniquely associated with a payment instrument of the user. The payment instrument identifiers are received from the user system 320.

At 520, the identity management system 350 receives a consent input from the user system 320, where the consent inputs contains the user's permission to link the data bundle or bundles containing the user identity attributes to the payment instrument identifier or identifiers.

At 525, the identity management system 350 generates a data record linking the payment instrument identifier(s) with the data bundle(s). The generated data record is provided in such a manner that if the identity management system 350 is queried using a payment instrument identifier, a response signal associated with the correlated data bundle is generated.

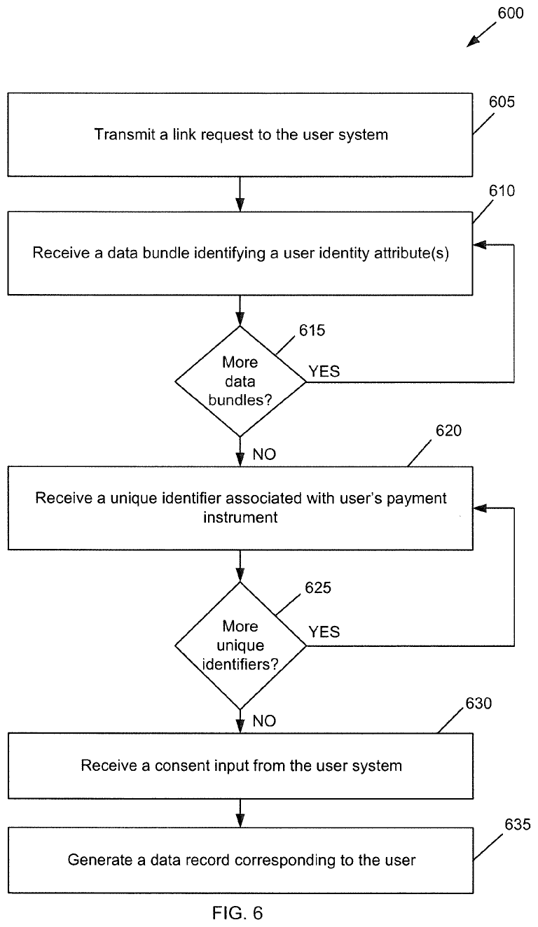

Reference is next made to FIG. 6, which illustrates an example of a process flow diagram of a transaction system according to the teachings herein, such as the transaction system 300 of FIG. 3. The various steps of the process flow of FIG. 6 are carried out by an identity management system, such as the identity management system 350 of FIG. 3. Process flow 600 is another example of correlating one or more user identity attributes with one or more payment instruments associated with the user.

Process flow 600 begins at 605, where the identity management system 350 transmits a link request to a user via the user system 320.

At 610, the identity management system 350 receives a data bundle that the user wishes to link to one or more payment instruments. The data bundle received at 610 may include a single user identity attribute or multiple user identity attributes.

At 615, the identity management system 350 determines if more data bundles should be added by the user or the user system 320. In one example, the identity management system 350 may determine this by prompting the user with a question regarding whether or not the user wants to add more data bundles. In another example, the identity management system 350 may require the user to provide an indicator of how many data bundles the user wishes to enter. In this example, if the indicated number of data bundles have not been entered, the identity management system 350 concludes that more data bundles should be added to the identity management system 350.

If the identity management system 350 determines that more data bundles should be added, the process proceeds to 610. However, if the identity management system 350 determines that no more data bundles should be added, the process proceeds to 620, where the identity management system 350 receives a payment instrument identifier from the user system 340. The payment instrument identifier corresponds to a unique payment instrument associated with the user.

Next, at 625, the identity management system 350 determines if more payment instrument identifiers should be added to the system 350. In one example, the identity management system 350 may determine this by prompting the user with a question regarding whether or not the user wants to add more payment instrument identifiers. In another example, the identity management system 350 may require the user to provide an indicator of how many payment instrument identifiers the user wishes to enter. In this example, if the indicated number of payment instrument identifiers have not been entered, the identity management system 350 concludes that more payment instrument identifiers should be added to the identity management system 350.

If the identity management system 360 determines that more payment instrument identifiers should be added to the system 360, the process proceeds to 620. However, if the identity management system 360 determines that more payment instrument identifiers should not be added to system 360, the process proceeds to 630.

At 630, the identity management system 360 receives a consent input from the user or the user system 320. In one example, the consent input indicates that the user consents to correlating the one or more data bundles added to the identity management system 360 at step 610 to the one or more payment instrument identifiers added to the identity management system 360 at 620. In another example, the consent input includes an indication from the user or the user system 320 specifying which of the one or more data bundles should be correlated which of the one or more payment instrument identifiers.

In one embodiment, the identity management system 360 provides a user interface to the user or the user system 320, where the user can select and match one or more data bundles to one or more payment instrument identifiers to indicate which data bundle or bundles should be matched with which payment instrument identifier or identifiers.

At 635, the identity management system 360 generates a data record linking the payment instrument identifier(s) with the data bundle(s). The process ends at 640.

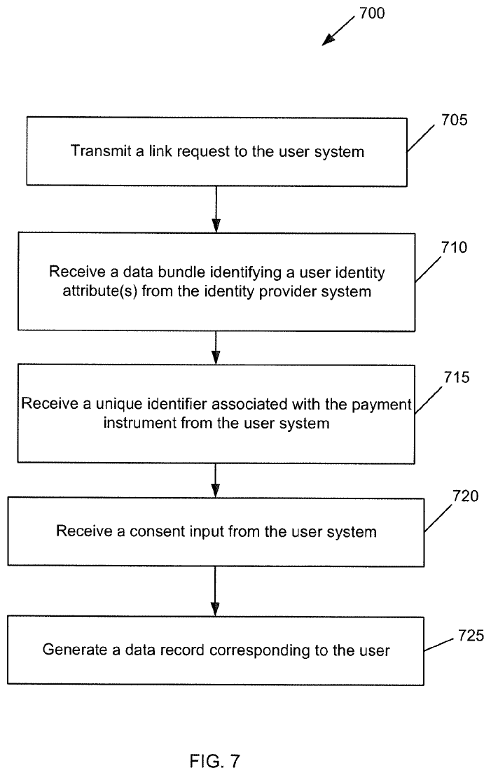

Reference is next made to FIG. 7, which illustrates an example of a process flow diagram 700 of a transaction system according to the teachings herein, such as the transaction system 300 of FIG. 3. The various steps of the process flow of FIG. 7 are carried out by an identity management system, such as the identity management system 350 of FIG. 3. Process flow 700 is another example of correlating one or more user identity attributes with one or more payment instruments associated with the user.

Process 700 starts at 705, which is analogous to step 505 of process flow 500 in FIG. 5.

At 710, the identity management system 360 receives one or more data bundles with each containing one or more user identity attributes from an identity provider system, such as the identity provider system 360.

In one example, when prompted by the link request at 505, the user system 320 transmits a request to the identity provider system 360 to provide the necessary data bundles. In this example, the user system 320 includes one or more claim categories within the request to the identity provider system 360. The identity provider system 360 then either generates the corresponding data bundles, or locates the corresponding data bundles within its memory. The generated or located data bundles are then transmitted to the identity management system 350.

In another example, when prompted by the link request at 505, the identity provider system 360 is automatically triggered to provide all the pre-generated data bundles corresponding to the user to the identity management system 350.

The subsequent steps 715, 720 and 725 of process flow 700 correspond to steps 515, 520 and 525 of process flow 500 respectively. The process 700 ends at 730.

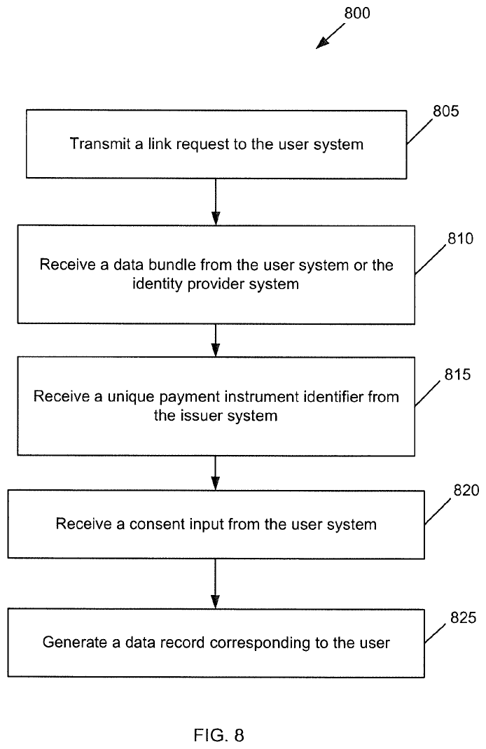

Reference is next made to FIG. 8, which illustrates an example of a process flow diagram 800 of a transaction system according to the teachings herein, such as the transaction system 300 of FIG. 3. The various steps of the process flow of FIG. 8 are carried out by an identity management system, such as the identity management system 350 of FIG. 3. Process flow 800 is yet another example of correlating one or more user identity attributes with one or more payment instruments associated with the user.

Process 800 starts at 805, which is analogous to step 505 of process flow 500 in FIG. 5. Next step 810 of process flow 800 is analogous to step 510 of process flow 500 or step 710 of process flow 700.

At 815, the identity management system 360 receives the payment instrument identifiers from the issuer system 340. In one example, when prompted by the link request at 805, the user system 320 authorizes the issuer system 340, corresponding to the payment instrument(s) that the user selects to the correlated to the data bundle or bundles, to provide the payment instrument identifier(s) for correlation. The user system 320 may authorize the issuer system 340 by logging or signing in to the user's account maintained by the issuer system 340, and then selecting the payment instrument or instruments that the user wishes to correlate with the data bundles. The issuer system 340 then transmits the unique identifier associated with each of the one or more payment instruments selected by the user.

In another example, when prompted by the link request at 805, the issuer system 340 pre-selected by the user or the user system 320 automatically transmits the payment instrument identifier or identifiers corresponding to the one or more pre-selected payment instruments desired by the user to be correlated.

The subsequent steps 820 and 825 of process flow 800 correspond to steps 520 and 525 of process flow 500 respectively. The process 800 ends at 830.

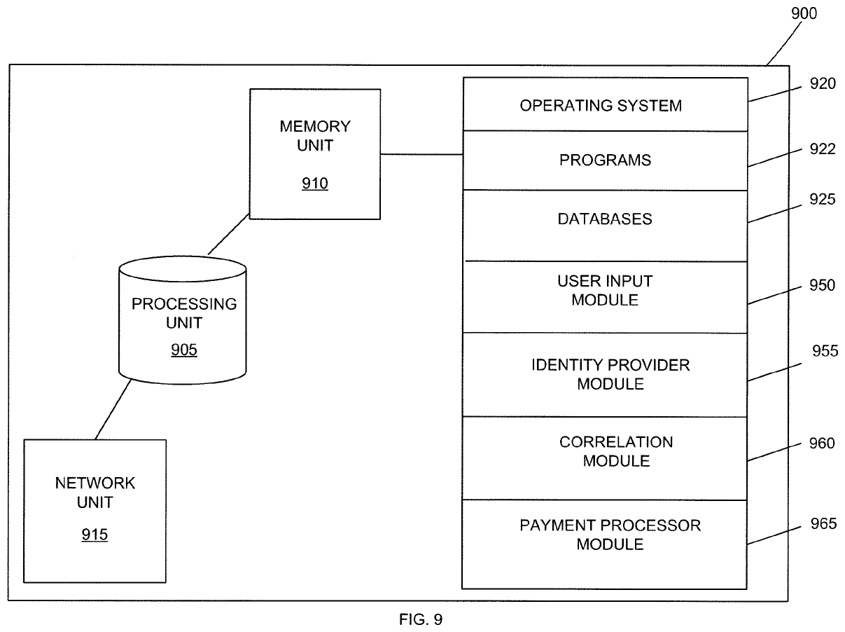

Reference is next made to FIG. 9, which illustrates a block diagram 900 of an identity management system, such as the identity management system 350, according to an example. Identity management system 900 comprises a processing unit 905, a memory unit 910 and a network unit 915.

The memory unit 915 can include RAM, ROM, one or more hard drives, one or more flash drives or some other suitable data storage elements such as disk drives, etc. The memory unit 915 is used to store an operating system 920 and programs 922 as is commonly known by those skilled in the art. For instance, the operating system 920 provides various basic operational processes for the operation of the identity management system 900.

The memory unit 910 may also accept data from one of the user input module 950, input provider module 955, correlation module 960 and payment processing module 965. The memory unit 910 uses the received data to define and store user records, as discussed below.

The user input module 950 interacts with at least one of the memory unit 910 and the databases 925 for corresponding with a user system, such as the user system 320. The user input module 950 may be configured to receive data bundle or bundles containing one or more user attributes from the user system 320. The user input module 950 may be additionally configured to receive one or more identifiers uniquely corresponding to one or more payment instruments associated with the user.

In at least one embodiment, the user input module 950 is configured to receive the user's consent to correlate the data bundle or bundles to the payment instrument or instruments associated with the user. The consent may be an express consent, or may be implied based on the provision of the data bundle(s) and payment instrument(s) for correlation.

In some embodiments, the user input module 950 also receives indication from the user or the user system 320 regarding which user attribute or attributes should be correlated with which payment instrument or instruments.

The user input module 950 may be additionally configured to prompt the user system to start the on-boarding process of correlation of user attributes and payment instruments. For example, the user input module 950 may inquire from the user system 320 if the user is ready to start the on-boarding procedure. The inquiry or the prompt may be displayed in a user interface in the user system 320.

The identity provider module 955 interacts with at least one of the memory unit 910 and the databases 925 for corresponding with an identity provider system, such as the identity provider system 360. The identity provider module 955 is configured to receive user attributes or corresponding data bundles from the identity provider system 360.

In some embodiments, when prompted by the identity management system 350 to start the on-boarding process, the user system 320 prompts the identity provider system 360 pre-linked with the user system 320 to provide the user attributes. In some cases, the user system 320 may specify the user attribute or attributes, or the corresponding data bundle or bundles that the identity provider system 360 should release to the identity management system 350. In such embodiments, the identity provider module 955 receives the data bundle(s) of user attribute(s) from the identity provider system 360.

In some embodiments, the identity provider module 955 also receives payment instrument information, such as payment instrument identifier or identifiers, from the identity provider system 360. For example, when prompted by the identity management system 350 to start the on-boarding process, the user system 320 prompts the identity provider system 360 pre-linked with the user system 320 to provide the payment instrument information. In some cases, the user system 320 may specify the payment instrument or instruments that the identity provider system 360 should release to the identity management system 350.

The correlation module 960 interacts with at least one of the memory unit 910 and the databases 925 for corresponding with the user input module 950, the identity provider module 955 and the payment processor module 965. The correlation module 960 is configured to correlate the user attribute(s) received from the user input module 950 or the identity provider module 955 with the payment instrument identifier(s) received from the user input module 950 or the identity provider module 955.

The correlation module 960 is configured to generate a user record database, where the correlation records of various users of the identity management system 350 are maintained.

The payment processor module 965 interacts with at least one of the memory unit 910 and the databases 925 for corresponding with a payment processing system, such as the payment processing system 315. The payment processor module 960 is configured to provide a user attribute or attributes when queried by a payment instrument identifier or identifiers.

As discussed above, when the payment processing system 315 queries the identity management system 350 by transmitting a unique identifier corresponding to the payment instrument used by the user at the merchant system 310, the payment processor module 965 transmit the corresponding user identity attribute or attributes that are correlated to the unique identifier during the on-boarding process.

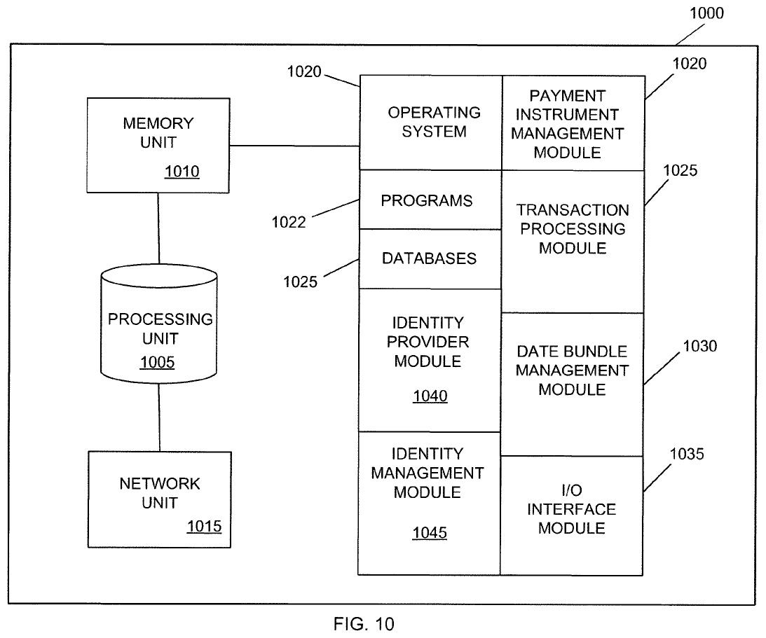

Reference is next made to FIG. 10, which illustrates a block diagram 1000 of a user system, such as the user system 320, according to an example. The user system 320 may be a user device, such as a personal computer, mobile phone etc. The user system 1000 comprises a processing unit 1005, a memory unit 1010 and a network unit 1015. The memory unit 1015 can include RAM, ROM, one or more hard drives, one or more flash drives or some other suitable data storage elements such as disk drives, etc. The memory unit 1015 is used to store an operating system 1020 and programs 1022 as is commonly known by those skilled in the art. For instance, the operating system 1020 provides various basic operational processes for the operation of the user system 1000.

The memory unit 1015 may also accept data from one of the payment instrument management module 1020, transaction processing module 1025, data bundle management module 1030, I/O interface module 1035, identity provider module 1040 and identity management module 1045.

The I/O interface module 1035 interacts with at least one of the memory unit 1010 and databases 1025, and is configured to provide a user interface to the user operating the user system 320. In particular, the I/O interface module 1035 is configured to receive user inputs or instructions. The I/O interface module 1035 is also configured to display information, such as notifications, questions etc. to the user.

The payment instrument management module 1020 interacts with at least one of the memory unit 1010 and the databases 1025, and is configured to store information corresponding to payment instruments associated with the user operating the user system 320. The user may use the I/O interface module 1035 to provide the payment instrument information to the user system 320. The user may alternatively or additionally scan the payment instrument to store the corresponding information on the user system 320.

The transaction processing module 1025 interacts with at least one of the memory unit 1010 and the databases 1025, and is configured to keep a record of transactions undertaken by the user system 320. The user system 320 may be used in transactions via mobile payment applications, such as Apple Pay, Google Pay etc.

The data bundle management module 1030 interacts with at least one of the memory unit 1010 and the databases 1025, and is configured to keep a record of verified user attributes. The verified user attributes may be stored as data bundle or bundles, where each data bundle may include one or more user attributes.

The identity provider module 1040 interacts with at least one of the memory unit 1010 and the databases 1025, and is configured to correspond to an identity provider system, such as the identity provider system 360. The identity provider module 1040 is configured to transmit claim category or categories selected by the user for which verified user attributes are required to the identity provider system 360. The identity provider module 1040 is also configured to receive data bundle(s) or verified user attribute(s) from the identity provider system 360.

The identity provider module 1040 is also configured to transmit a request to the identity provider system 360 to directly the verified user attribute(s) or data bundles(s) to an identity management system, such as the identity management system 350, during the on-boarding process.

In some cases, the identity provider module 1040 transmits the claim category or categories to the identity management system 350 for which verified user attributes or data bundles need to be generated and transmitted to the identity management system 350.

In some other cases, the identity provider module 1040 transmits an identifier for the previously generated data bundles or verified user attributes to the identity provider system 360, following which the identity provider system 360 transmits the corresponding data bundles or user attributes to the identity management system 350.

The identity provider module 1040 is also configured to transmit a request to an identity provider system, such as the identity provider system 360, to provide information corresponding to payment instrument or instruments associated with the user to the identity management system 350.

The identity management module 1045 interacts with at least one of the memory unit 1010 and the databases 1025, and is configured to correspond to an identity management system, such as the identity management system 350. The identity management module 1045 is configured to transmit the data bundle or bundles of verified user attribute or attributes to the identity management system 350 during the on-boarding process.

The identity management module 1045 is also configured to transmit payment instrument information, such as payment instrument identifier, to the identity management system 350 during the on-boarding process.

The identity management module 1045 is also configured to transmit user instructions corresponding to which user attribute(s) to be correlated to which payment instrument(s). The user instruction may be provided via the I/O interface module 1035 and transmitted to the payment management system 350 via the identity management module 1045.

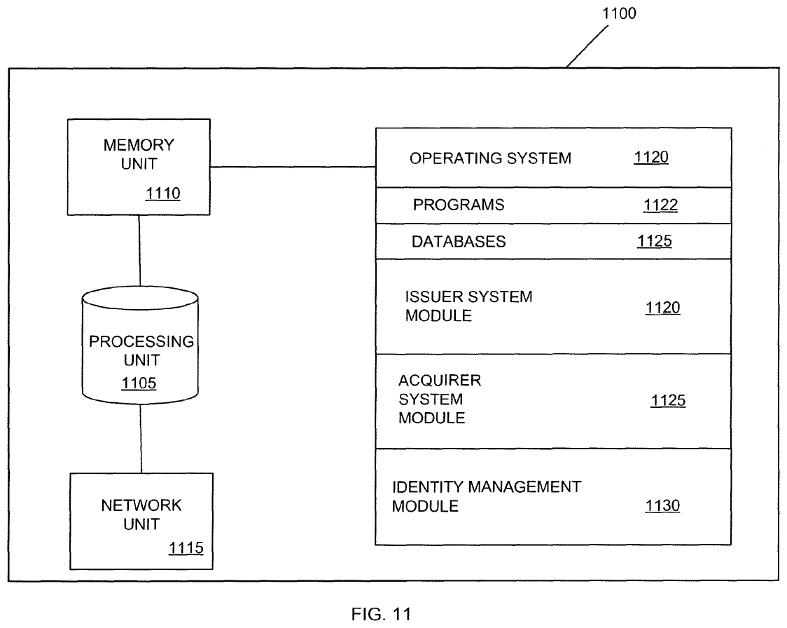

Reference is next made to FIG. 11, which illustrates a block diagram 1100 of a payment processing system, such as the payment processing system 315, according to an example. The payment processing system 1100 comprises a processing unit 1105, a memory unit 1110 and a network unit 1115. The memory unit 1115 can include RAM, ROM, one or more hard drives, one or more flash drives or some other suitable data storage elements such as disk drives, etc. The memory unit 1115 is used to store an operating system 1120 and programs 1122 as is commonly known by those skilled in the art. For instance, the operating system 1120 provides various basic operational processes for the operation of the payment processing system 1100.

The memory unit 1115 may also accept data from one of the issuer system module 1120, the acquirer system module 1125 and the identity management module 1130.

The acquirer system module 1125 is configured to receive a unique identifier associated with a payment instrument belonging to a user, which was used by the user or the user system at the merchant POS.

The acquirer system module 1125 is also configured to transmit a verification indicator to the merchant system 310 directly or via the acquirer system 330. The verification indicator is a rejection indicator if the verification of the response indicates an unsuccessful transaction. Similarly, the verification indicator is an approval indicator if the verification of the response indicates a successful transaction.

The issuer system module 1120 is configured to transmit the unique identifier associated with the payment instrument to an issuer system, such as the issuer system 340, for payment verification.

The issuer system module 1120 is also configured to receive a verification response from the issuer system 340. The verification response contains an indication of whether or not the payment transaction verification is successful or not.

The issuer system module 1120 is also configured to analyze the verification response and determine whether or not the verification was successful.

The identity management module 1130 is configured to transmit unique identifier or identifiers associated with a corresponding payment instrument or instruments to an identity management system, such as the identity management system 350.

The identity management module 1130 is also configured to receive one or more user identity attributes associated with the unique identifier of the user's payment instrument from the identity management system 350. The received one or more user identity attributes may be in the form of data bundles.

The identity management module 1130 is also configured to transmit the one or more user identity attributes received from the identity management system 350 to the merchant system 310 either directly or via the acquirer system 330.

The present invention has been described here by way of example only, while numerous specific details are set forth herein in order to provide a thorough understanding of the exemplary embodiments described herein. However, it will be understood by those of ordinary skill in the art that these embodiments may, in some cases, be practiced without these specific details. In other instances, well-known methods, procedures and components have not been described in detail so as not to obscure the description of the embodiments. Various modification and variations may be made to these exemplary embodiments without departing from the spirit and scope of the invention, which is limited only by the appended claims.

We claim:

1. A method for authenticating a user identity attribute associated with a user during a transaction with a merchant, the user operating a user device and being related to a user agent server, the method comprising:
receiving, at a payment processor, at least one unique identifier corresponding to a first payment instrument provided by the user at a merchant terminal, the first payment instrument being pre-linked to one or more user identity attributes by a third party server;
transmitting the at least one unique identifier to an issuer network for payment verification;
if payment verification is successful, generating a transaction approval indicator, and transmitting the at least one unique identifier and an identity verification request from the payment processor to the third party server;
in response to the identity verification request, receiving the one or more user identity attributes associated with the at least one unique identifier from the third party server; and
subsequently transmitting the one or more user identity attributes and the transaction approval indicator to the merchant terminal.

2. The method of claim 1, wherein the at least one unique identifier comprises a primary account number associated with the first payment instrument.

3. The method of claim 1, wherein the at least one unique identifier comprises a hash of a primary account number associated with the first payment instrument.

4. The method of claim 1, wherein the at least one unique identifier comprises a cryptogram based on a primary account number associated with the first payment instrument, the cryptogram being an encrypted version of the primary account number.

5. The method of claim 1, wherein at least one user identity attribute transmitted to the merchant terminal comprises a photograph of the user.

6. The method of claim 1, wherein at least one user identity attribute transmitted to the merchant terminal comprises an age of the user.

7. The method of claim 1, further comprising:
receiving a cancellation request, at the payment processor, from the merchant terminal, the cancellation request being generated if the one or more user identity attributes fail to meet one or more identity conditions associated with the transaction; and
storing the cancellation request and the at least one unique identifier associated with the first payment instrument.

8. The method of claim 1, further comprising:
receiving an approval request, at the payment processor, from the merchant terminal, the approval request being generated if the one or more user identity attributes meet one or more identity conditions associated with the transaction; and
storing the approval request and the at least one unique identifier associated with the first payment instrument.

9. The method of claim 1, wherein the third party server determines the one or more user identity attributes based on the at least one unique identifier in response to the identity verification request.

10. The method of claim 1, wherein the third party server transmits the at least one unique identifier associated with the first payment instrument to the issuer network to detokenize the at least one unique identifier and generate a corresponding at least one processed unique identifier, and wherein the third party server determines the one or more user identity attributes based on the at least one processed unique identifier in response to the identity verification request.

11. A method for linking a user identity attribute associated with a user to a payment instrument associated with the user to facilitate a transaction between a merchant and the user, the user being related to a user agent server, the method comprising:
transmitting, from an identity management server, a link request to the user agent server;
in response to the link request, receiving, at the identity management server, a data bundle identifying at least one user identity attribute associated with the user and at least one unique identifier associated with a corresponding at least one payment instrument associated with the user;
receiving, at the identity management server, a consent input from the user agent server, the consent input identifying a user permission to link the user identity attribute with the payment instrument; and
based on the consent input, generating a data record linking the at least one unique identifier with the data bundle, wherein if the identity management server is queried using the at least one unique identifier, a response signal associated with the data bundle is generated.

12. The method of claim 11, further comprising:
receiving at least one payment transaction request from the user agent server, the at least one payment transaction request being generated using a corresponding at least one payment instrument associated with the user, each of the at least one payment transaction request identifying a unique identifier associated with the corresponding at least one payment instrument;
for each of the at least one payment transaction request:
processing that payment transaction request for a corresponding payment verification; and
if payment verification is successful, processing that payment transaction request to generate the unique identifier associated with the payment instrument corresponding to that payment transaction.

13. The method of claim 12, wherein for each of the at least one payment transaction request, the method further comprises:
transmitting the unique identifier to an issuer network to detokenize the unique identifier associated with the payment instrument related to the user; and
generating a corresponding processed unique identifier,
wherein the data record is updated to additionally link the processed unique identifier with the data bundle of the user.

14. The method of claim 11, wherein the response signal comprises the data bundle.

15. The method of claim 11, wherein the response signal comprises the at least one user identity attribute contained in the data bundle.

16. The method of claim 11, wherein the data bundle is generated by an identity provider server.

17. The method of claim 16, wherein the data bundle is received from the identity provider server based on user authorization to release the data bundle.

18. The method of claim 11, wherein the data bundle is stored locally at the user agent server.

19. The method of claim 18, wherein the data bundle is received by the identity management server from the user agent server.

20. The method of claim 11, wherein the data bundle is generated by an identity provider server based on a user request to generate the data bundle, the user request identifying one or more claim categories.

21. The method of claim 11, further comprising:
receiving an identity verification request from a payment processor server, the identity verification request identifying a unique identifier;
querying the data record based on the unique identifier to generate one or more user identity attributes; and
subsequently generating the response signal for transmission to the payment processor server, the response signal comprising the one or more user identity attributes.

22. An authentication system for authenticating a user identity attribute associated with a user during a transaction with a merchant, the system comprising:
a memory unit; and
a processing unit coupled to the memory unit, the processing unit being configured to:
receive at least one unique identifier corresponding to a first payment instrument provided by the user at a merchant terminal, the first payment instrument being provided by the user for purchase of a good or service from the merchant,
the first payment instrument being pre-linked to one or more user identity attributes by a third party server;
transmit the at least one unique identifier to an issuer network for payment verification;
if payment verification is successful, generate a transaction approval indicator, and transmit the at least one unique identifier and an identity verification request to the third party server;
in response to the identity verification request, receive the one or more user identity attributes associated with the at least one unique identifier from the third party server; and
subsequently transmit the one or more user identity attributes and the transaction approval indicator to the merchant terminal.

23. A system for linking a user identity attribute associated with a user to a payment instrument associated with the user to facilitate a transaction between a merchant and the user, the system comprising:
a memory unit; and
a processing unit coupled to the memory unit, the processing unit being configured to:
transmit a link request to a user agent server;
in response to the link request, receive a data bundle identifying at least one user identity attribute associated with the user and at least one unique identifier associated with a corresponding at least one payment instrument associated with the user;
receive a consent input from the user agent server, the consent input identifying a user permission to link the user identity attribute with the payment instrument; and
based on the consent input, generate a data record linking the at least one unique identifier with the data bundle, wherein if the processing unit is queried using the at least one unique identifier, a response signal associated with the data bundle is generated.

24. A non-transitory computer-readable storage medium storing computer-executable instructions, the instructions for causing a processor to perform a method for authenticating a user identity attribute associated with a user during a transaction with a merchant, the user operating a user device and being related to a user agent server, the method comprising:
receiving, at a payment processor, at least one unique identifier corresponding to a first payment instrument provided by the user at a merchant terminal, the first payment instrument being pre-linked to one or more user identity attributes by a third party server;
transmitting the at least one unique identifier to an issuer network for payment verification;
if payment verification is successful, generating a transaction approval indicator, and transmitting the at least one unique identifier and an identity verification request from the payment processor to the third party server;
in response to the identity verification request, receiving the one or more user identity attributes associated with the at least one unique identifier from the third party server; and
subsequently transmitting the one or more user identity attributes and the transaction approval indicator to the merchant terminal.

25. A non-transitory computer-readable storage medium storing computer-executable instructions, the instructions for causing a processor to perform a method for linking a user identity attribute associated with a user to a payment instrument associated with the user to facilitate a transaction between a merchant and the user, the user being related to a user agent server, the method comprising:
transmitting, from an identity management server, a link request to the user agent server;
in response to the link request, receiving, at the identity management server, a data bundle identifying at least one user identity attribute associated with the user and at least one unique identifier associated with a corresponding at least one payment instrument associated with the user;
receiving, at the identity management server, a consent input from the user agent server, the consent input identifying a user permission to link the user identity attribute with the payment instrument; and
based on the consent input, generating a data record linking the at least one unique identifier with the data bundle, wherein if the identity management server is queried using the at least one unique identifier, a response signal associated with the data bundle is generated.
